(19) United States
(12) Patent Application Publication
(10) Pub. No.: US 2025/0027612 A1
(43) Pub. Date: Jan. 23, 2025

(54) ACTIVE VENTING CONTROL SYSTEM FOR HYDROGEN FUEL TANKS

(71) Applicant: Universal Hydrogen Co., Hawthorne, CA (US)

(72) Inventors: Theophile Coutant, Hawthorne, CA (US); Nick Macdonald, Hawthorne, CA (US); Daniel Costa Blanes, Hawthorne, CA (US); Stephane Valadon, Hawthorne, CA (US)

(21) Appl. No.: 18/545,971

(22) Filed: Dec. 19, 2023

Related U.S. Application Data
(60) Provisional application No. 63/515,059, filed on Jul. 21, 2023.

(51) Int. Cl. F17C 7/02

(52) U.S. Cl. CPC F17C 7/02; F17C 2201/0109; F17C 2205/0326; F17C 2205/0332; F17C 2221/012; F17C 2223/0161; F17C 2223/033; F17C 2250/0417; F17C 2250/043; F17C 2250/0439; F17C 2250/0491; F17C 2250/0694; F17C 2270/0168

(57) ABSTRACT

The present disclosure provides active venting control systems for use with liquid hydrogen tanks. The active venting control system allows a greater mass of hydrogen to be safely stored for a greater period of time. The systems is configured to actively monitor, control, and vent hydrogen based on a combination of pressure and fill level within the tank. When the tank reaches a predetermined fill level, the active venting control system is configured to vent the tank for a predetermined period of time. The active venting control system is configured to repeat the process during a transit and storage time, allowing the tank to be filled with a higher initial fill level and hold a greater mass of hydrogen compared to passive pressure relief systems.

### CROSS-REFERENCE TO RELATED APPLICATION

The present application is a U.S. non-provisional patent application that claims the benefit of and priority to U.S. Provisional Patent Application No. 63/515,059, titled ACTIVE VENTING CONTROL SYSTEM FOR HYDROGEN FUEL TANKS, filed Jul. 21, 2023, which is fully incorporated herein by reference thereto.

### TECHNICAL FIELD

The present disclosure relates to venting control systems for hydrogen fuel tanks, and more particularly to active venting control systems for modular, liquid hydrogen fuel tanks for vehicles.

### BACKGROUND

Hydrogen is a clean energy source that can be used to power various vehicles, including aircraft or other vehicles. The hydrogen fuel is typically stored in tanks or other selected vessels as a gaseous fuel or stored at cryogenic conditions in a liquid state. Hydrogen fuel provides a distinct advantage over other types of power sources. For example, aviation gas or jet fuel has specific energies that may generally range from about 43 MJ/kg to about 48 MJ/kg. In contrast, hydrogen has a specific energy that may generally range from about 120 MJ/kg to about 140 MJ/kg. Thus, using hydrogen as a fuel source for vehicles can reduce the fuel weight onboard vehicles, while providing a comparable amount of energy as other traditional sources of fuel. Further, burning carbon-based fuels generates exhaust with a variety of atmospheric contaminates, such as carbon dioxide. Consuming hydrogen for fuel, however, only emits benign or nontoxic byproducts, such as water, thereby reducing the environmental impacts of various modes of transportation that use hydrogen as a fuel source.

During storage and transportation of hydrogen fuel tanks to aircraft or other vehicles powered by hydrogen, and during storage periods, ambient heat from outside the hydrogen fuel tank will infiltrate the tank due to imperfect thermal insulation. The heat causes the liquid hydrogen to expand, which increases the pressure within the tank. Therefore, it is necessary to vent the tank to avoid over-pressurization. However, each time the tank is vented, a portion of the gaseous hydrogen is released, which means that fuel from the tank is lost. Moreover, the aircraft or other vehicle may have operational requirements for the hydrogen to be at a certain pressure. Thus, it is necessary to have a hydrogen tank and venting system that can minimize fuel loss and meet operational requirements in a safe and efficient manner.

### SUMMARY

The technology of the present disclosure overcomes the above drawbacks and provides additional benefits. For example, one or more embodiments of the present technology provides a liquid hydrogen tank module assembly that comprises a liquid hydrogen fuel tank within a module housing. The tank is configured to contain liquid hydrogen at cryogenic conditions and gaseous hydrogen in a headspace above the liquid hydrogen. A plurality of sensors is operatively coupled to the hydrogen fuel tank and configured to measure a liquid temperature, a vapor temperature, a tank pressure, and a hydrogen mass. The hydrogen mass is a total mass of the liquid hydrogen and the gaseous hydrogen in the tank's internal volume. The assembly has a passive pressure relief valve and an active venting control system. The passive relief valve is coupled to the interior of the hydrogen fuel tank and configured to automatically move to an open position when the tank pressure exceeds a relief pressure threshold. The active venting control system has an active venting valve is movable between a closed position and an open position and that is operatively coupled to the hydrogen fuel tank for communication with the gaseous hydrogen.

A controller is coupled to the sensors and is configured to receive outputs from the sensors. The controller is also configured to calculate a vapor density based on the vapor temperature and the tank pressure, a liquid density based on the liquid temperature and the tank pressure, an average density based on the hydrogen mass and the tank volume, and an effective fill level based on the vapor density, the liquid density, and the average density. The controller is configured to move the active venting valve from the closed position to the open position when the effective fill level exceeds an initial fill level threshold and move the active venting valve to the closed position when a secondary threshold is reached after reaching the initial fill level threshold.

Other embodiments of the present technology provides a liquid hydrogen tank assembly including a liquid hydrogen fuel tank configured to contain hydrogen fuel in liquid and gaseous states. A passive pressure relief valve is coupled to the interior of the hydrogen fuel tank and configured to automatically move to an first open position when an interior pressure within the tank exceeds a relief pressure threshold. A plurality of sensors are operatively coupled to the liquid hydrogen fuel tank and configured to measure conditions within the liquid hydrogen fuel tank. The sensors include a pressure sensor configured to determine an interior pressure within the tank volume and a fill level sensor configured to obtain data to determine a fill level of the liquid hydrogen within the tank volume. The assembly also includes an active venting control system coupled to the liquid hydrogen fuel tank and to the plurality of sensors. The active venting control system has an active venting valve and a controller. The active venting valve is movable between closed and open positions and operatively communicates with the gaseous hydrogen located in the headspace above the liquid hydrogen in the tank volume. The controller is coupled to the sensors and to the active venting valve. The controller is configured to receive outputs from the sensors, and to determine an effective fill level of the liquid hydrogen and the pressure within the tank volume. The controller is configured to move the active venting valve from the closed position to the open position when the effective fill level exceeds an initial fill level threshold and configured to move the active venting valve to the closed position when a secondary threshold is reached after reaching the initial fill level threshold.

### BRIEF DESCRIPTION OF THE DRAWINGS

A better understanding of the features and advantages of the present disclosure will be obtained by reference to the following detailed description that sets forth illustrative embodiments, in which the principles of the disclosure are utilized, and the accompanying drawings.

FIG. 1 is a perspective view of a modular hydrogen-fuel storage assembly with one or more liquid hydrogen tanks configured for use with an active venting control system in accordance with embodiments of the present technology.

FIG. 2 is an enlarged perspective view of a liquid hydrogen tank with a controllable, active venting control system of an embodiment of the present technology.

FIG. 3 is a schematic illustration of the active venting control system of an embodiment of the present technology.

FIG. 4 is a flowchart illustrating operation of an active venting control system of an embodiment of the present technology.

FIGS. 5A, 5B, and 5C are schematic graphs illustrating hydrogen mass change over time, fill level change over time, and tank pressure change over time, respectively, in a liquid hydrogen fuel tank with a passive pressure relief valve and an active venting valve of an active venting control system of one or more embodiments of the present technology.

FIG. 6 is a schematic graph illustrating a saturation curve of hydrogen in a liquid hydrogen fuel tank with a passive pressure relief valve and an active venting valve of an active venting control system of an embodiment of the present technology.

FIGS. 7A and 7B are side and schematic views of a catalyst configured to be coupled to one or more active venting control systems of various embodiments of the present technology.

A person skilled in the relevant art will understand that the features shown in the drawings are for purposes of illustrations, and variations, including different and/or additional features and arrangements thereof, are possible.

### DETAILED DESCRIPTION

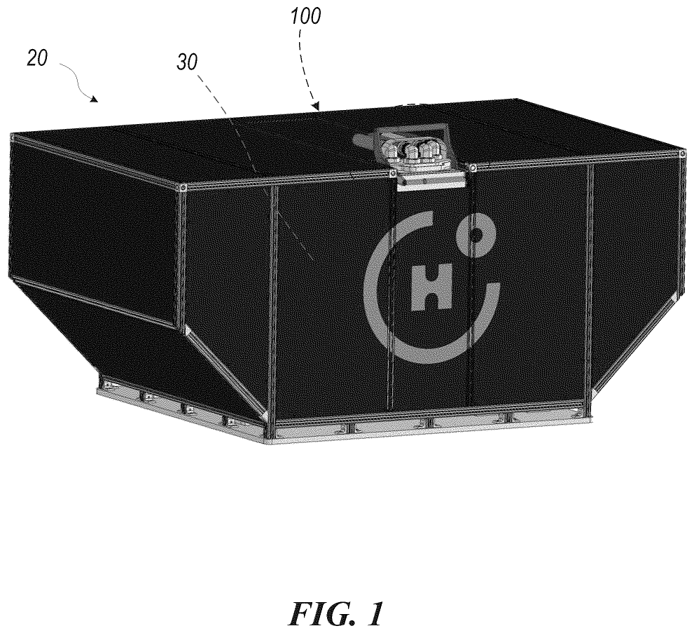

The present technology is directed to active venting control systems configured for use with liquid hydrogen fuel tanks or tanks filled with other types of fuel stored in the liquid state at cryogenic temperatures. Specific details of the present technology are described herein with respect to FIGS. 1-7B. Although many of the embodiments are described with respect to liquid hydrogen fuel tank assemblies or systems, it should be noted that other applications and embodiments in addition to those disclosed herein are within the scope of the present technology. Further, embodiments of the present technology can have different configurations, components, and/or procedures than those shown or described herein. Moreover, a person of ordinary skill in the art will understand that embodiments of the present technology can have configurations, components, and/or procedures in addition to those shown or described herein and that these and other embodiments can be without several of the configurations, components, and/or procedures shown or described herein without deviating from the present technology.

While various embodiments of the present technology are shown and described herein, it will be obvious to those skilled in the art that such embodiments are provided by way of example only. Numerous variations, changes, and substitutions may occur to those skilled in the art without departing from the scope of the present technology. It should be understood that various alternatives to the embodiments described herein may be employed. Further, components disclosed in connection with one described embodiment may be included or usable in or with other embodiments even if not specifically shown or described. Some components described or shown in connection with an embodiment may not be required and may be excluded while still being within the scope of the applicant's inventive technology.

In an aspect, the present disclosure provides an active venting control system in or coupled to one or more modular, liquid hydrogen fuel storage tank assemblies configured for use on a vehicle, such as an aircraft. In some embodiments, the modular tank assemblies can be configured to be stored remotely from a vehicle, transported to the vehicle, and removably installed in the vehicle to provide the hydrogen fuel for the vehicle's power train (e.g., fuel cell system) or other hydrogen-based power plant. The tank assemblies can then be removed from the vehicle and transported to a remote location away from the vehicle to be refilled and stored until it is needed for a vehicle. The active venting control system may be configured to actively vent gaseous hydrogen from within the tanks based on the tank pressure and fill level to maintain a maximum amount of liquid hydrogen in the tank during filling, storage, transport, and installation into the hydrogen-powered aircraft, while maintaining a pressure in the tank at or below a selected maximum or operational pressure. In some cases, the liquid hydrogen tank in the assembly is configured to contain a volume of hydrogen in a liquid state at cryogenic conditions, along with a portion of gaseous hydrogen that fills the headspace within the tank assembly above the liquid hydrogen. As the temperature within the tank rises and some liquid hydrogen converts to a gaseous stage, the pressure within the tank increases. The active venting system monitors the temperature, pressure, liquid volume, and/or other internal conditions, and the system is configured to actively vent hydrogen gas from the tank to carefully control the amount of hydrogen released, while maximizing retention of the hydrogen fuel at safe pressures for subsequent use once the tank is coupled to the aircraft or other vehicle. In addition to the active venting system, the tank assembly also includes a conventional passive pressure relief valve configured to open if gas pressure in the tank exceeds a designated level.

In some embodiments, a liquid hydrogen fuel tank assembly with an active venting control system in accordance with the present technology is configured to monitor conditions in the tank, including liquid fill level, temperature, and pressure, and actively open a valve via a controller during a storage and/or transit storage period whenever an effective fill level reaches a predetermined fill level that is determined based on the tank pressure and characteristics of the stored liquid hydrogen (e.g., volume, density, and/or temperature) in the tank. The effective fill level is the effective percentage of total tank volume occupied by liquid hydrogen. The active venting control system is configured to allow the hydrogen fuel tank to be filled at a higher initial fill level compared to hydrogen fuel tanks vented using conventional passive valves that open when a predetermined venting pressure is reached. The active venting control system is also configured to provide substantive mass savings by venting less hydrogen from the tank from the compared to conventional passive venting systems.

For example, a hydrogen fuel tank with a suitable volume and using only a conventional system with passive venting at 9 bar can be filled with liquid hydrogen with an initial mass of up to only 148 kg and an initial fill level of 70% of the tank's volume, and after 200 hours of storage and passive venting to keep internal pressures at or below 9 bar, only 114 kg of hydrogen will remain. By contrast, a similar modular, liquid hydrogen fuel tank with the same volume and a 9 bar pressure limit and that has the active venting control system in accordance with embodiments of the present technology can be filled with an initial mass of up to 195 kg and an initial fill level of 92% of the same tank volume, such that after storage of 200 hours in the same environmental conditions, the tank will retain 158 kg of hydrogen for subsequent use by the aircraft or other vehicle once the modular tank assembly is installed and the fuel system activated. Accordingly, the active venting system allows for approximately a 31.8% increase in initial mass of the stored hydrogen, and approximately a 38.6% increase in retained hydrogen after 200 hours.

FIGS. 1-3 are views of the hydrogen fuel module 20 containing a liquid hydrogen fuel tank assembly 30 with the active venting control system 100 of embodiments of the present technology. Hydrogen fuel tank modules 20 can be configured to be removably loaded into and securely retained in an aircraft or other vehicle with a hydrogen-powered powerplant system. The fuel storage modules 20 can include the modules and components described in U.S. Pat. No. 11,525,544, titled Fuel Storage Module Assembly, and/or U.S. patent application Ser. No. 18/311,209, titled Modular Hydrogen-Fuel Storage Assembly, filed May 2, 2023, each of which is incorporated herein in its entirety by reference thereto. The hydrogen fuel tank assembly 30 can include fuel tanks and components as disclosed in U.S. Patent Application Publication No. 2022/0136656, titled Systems and Methods for Storing Liquid Hydrogen, which is incorporated herein in its entirety by reference thereto. The liquid hydrogen fuel tank assemblies 30 are configured to be filled with hydrogen fuel, such as at a filling location remote from the aircraft or other vehicle. The fuel tank modules 20 with the active venting control system 100 can be stored remotely and/or transported to the aircraft or other vehicle for installation and connection to the vehicle's fuel and power plant system. The active venting system 100 is configured to actively monitor and control the pressure and conditions within the tank, so as to reduce the amount of hydrogen fuel that needs to be vented from the tanks while maintaining the targeted internal pressure, temperature, and fill volumes during filling, storage, and transportation of the module to the aircraft or other vehicle.

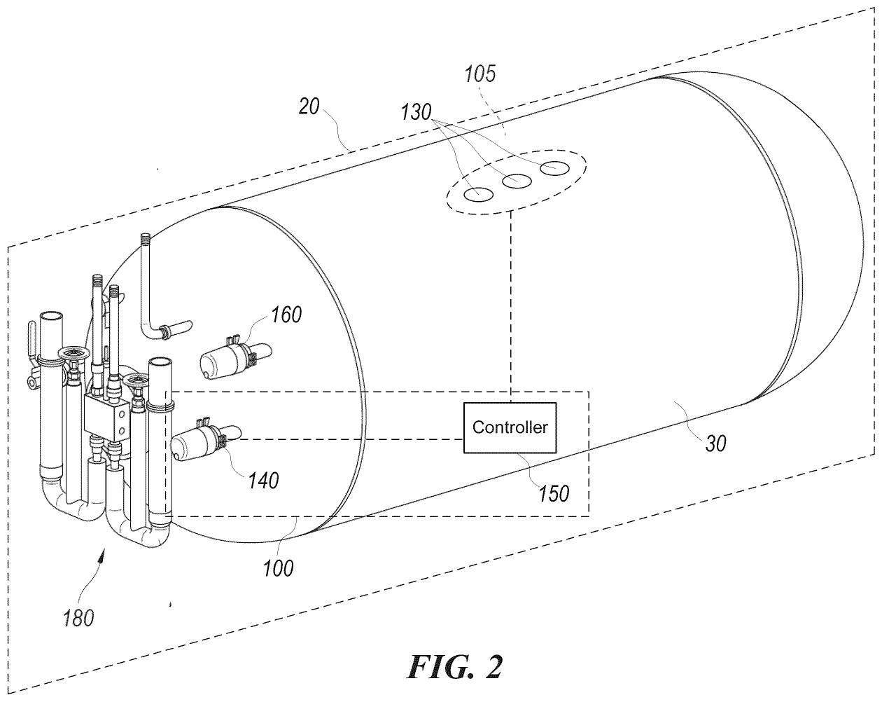

As seen in FIG. 2, the illustrated active venting system 100 includes an active venting valve 140 and a controller 150. The active venting valve 140 is coupled to the tank assembly 30 and configured to be activated to selectively and accurately release gaseous hydrogen from the tank 30 to reduce the internal pressure within the liquid hydrogen fuel tank assembly 30. The sensors 130 and active venting valve 140 are connected to a controller 150, which can be within the module 20 and positioned adjacent to the tank 30. In other embodiments, the controller 150 can be attached to the exterior of the tank module 20. The controller 150 can be configured to communicate with the sensors 130, the active venting valve 140, and/or other components of the active venting control system 100 or the hydrogen tank assembly 30 through a wired communication link or wirelessly. The controller 150 can be configured to communicate with more than one active venting valve 140 and sensors in or on a plurality of liquid hydrogen fuel tank assemblies 30, such as multiple tank assemblies within one module. The controller 150, active venting valve 140, and/or the sensors 130 can be coupled to a power source (e.g., a battery or other selected onboard or exterior power source).

The liquid hydrogen fuel tank assembly 30 has a refillable, insulated, multi-walled tank with an interior 105 that contains the liquid hydrogen fuel in the cryogenic conditions. A plumbing system 180 is attached to the tank and in fluid communication with the tank's interior 105. The plumbing system 180 has inlet and outlet fuel lines, such that the tank can be filled via the inlet line(s) to a selected fill level with liquid hydrogen, and hydrogen fuel can be removed from the tank during use in the aircraft (or other vehicle) via the outlet line(s). The tank's plumbing system 180 also includes a passive pressure relief valve 160 configured to remain in a closed sealed position until the pressure within the interior exceeds an elevated threshold level above a desired storage and operational internal pressure. In the event the pressure within the tank ever exceeds the threshold pressure, the passive pressure relief valve 160 is automatically forced to an open position to release some hydrogen from within the tank 30, thereby reducing the tank's internal pressure to below the threshold level. It is noted that the active venting system 100 is configured to actively and carefully control the liquid hydrogen tank's internal pressure, and the passive pressure relief valve 160 simply acts as an automatic back up to the active venting system 100 if required by internal or external conditions.

In the illustrated embodiment, the liquid hydrogen fuel tank assembly 30 is configured to be filled or refilled with liquid hydrogen to a selected fill level, such that the space within the tank's interior above the liquid (i.e., the headspace) will be filled with gaseous hydrogen. The liquid hydrogen fuel tank assembly 30 of the illustrated embodiment is configured to be filled or refilled with the liquid hydrogen at cryogenic temperatures and at a selected pressure range, such as approximately 4-6 bar or preferably up to approximately 7 bar. The liquid hydrogen fuel tank assembly 30 in other embodiments can be configured to retain the hydrogen at other temperatures and pressure ranges for selected configurations during storage and/or transit after being filled and prior to installation onto the aircraft or other vehicle. The liquid hydrogen fuel tank assembly 30 retains the liquid hydrogen fuel during storage/transit for up to a selected time period, and the active venting system 100 closely monitors and controls the tank's internal pressure so as to maximize the allowable initial fill level as well as the internal pressure so as to maximize storage or hold times with minimized hydrogen fuel loss through venting. In some embodiments, the tank's hold time after initial filling and before installation of the module 20 into an aircraft (or other vehicle) can be up to approximately 200 hours with minimized loss through venting. Other embodiments can provide for other maximum hold times. In some embodiments, the tank module 20 is also configured with a hydrogen leak and fire detection system 110 for added protection.

The hydrogen fuel modules 20 are stored, transported, used, and otherwise exist in substantially ambient environments. After a liquid hydrogen fuel tank assembly 30 is filled or refilled with the liquid hydrogen fuel at the cryogenic conditions, heat from outside the tank will slowly transfer through the tank to the liquid hydrogen within the tank. As a result, if not controlled, the liquid hydrogen will slowly expand, and the tank pressure will increase over time. The sensors 130 of the active venting system 100 can include a plurality of different sensors, such as a liquid temperature sensor, a vapor temperature sensor 131, a tank pressure sensor 133, a hydrogen mass sensor, a fill-level sensor 135, a health monitoring sensor, and other types of sensors. The sensors 130 can communicate various measurements to the controller 150.

In some embodiments, the controller 150 can be a hardware controller with a central processing unit (CPU) that a receives and interprets signals (e.g., digital signals) from the sensors 130 using a conventional communication protocol. The CPU can be a single processing unit or multiple processing units in a device or distributed across multiple devices. The CPU may be onboard the hydrogen fuel module 20, or the CPU can be remote from the module. The CPU can use the sensor information, calculate the internal conditions within the tank, and communicate with the active vent assembly to cause the active venting valve 140 to move between the open and closed positions depending upon the combination of sensor information about the fill level, the temperature, and/or the pressure. The controller 150 may be or include a computing device that accesses computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions. In addition, the stored information may be encrypted. The data transmission media are used for transmitting data via transitory propagating signals or carrier waves (e.g., electromagnetism) via a wired or wireless connection. In addition, the transmitted information may be encrypted.

The controller 150 can be configured to operatively move the active venting valve 140 between open and closed positions based on calculations performed by the controller 150 using the measurements received from the sensors 130. When the controller 150 causes the active venting valve 140 to move to the open position, the valve 140 releases gaseous hydrogen from the tank at a fixed or varying rate. When controller 150 causes the active venting valve 140 to move to the closed position, release of the gaseous hydrogen stops until the valve is opened again.

The active venting valve 140 can include a valve actuator 142 and a vacuum jacket 146. The valve actuator 142 is operatively coupled to the controller and can be configured to actuate the valve 140 to move the valve between the open and closed positions in response to instructions from the controller 150. The vacuum jacket 146 can be configured to reduce heat transfer between the active venting valve 140 and the liquid hydrogen to maintain a suitable operational temperature. Because the liquid hydrogen is stored at cryogenic temperatures, the active venting valve 140 and/or other components (e.g., the sensors 130) must be able to operate at low temperatures. In some embodiments, the active venting valve 140 can be positioned at least partially in a cold box 144 within the tank module. The cold box 144 provides a thermally controlled environment for the active venting valve 140 and other plumbing or hydrogen fuel lines coupled to the tank. This controlled environment can help maintain the temperature and pressure around the active venting valve 140, so as to decrease the potential impact of the temperature and/or pressures of the ambient environment surrounding the tank module.

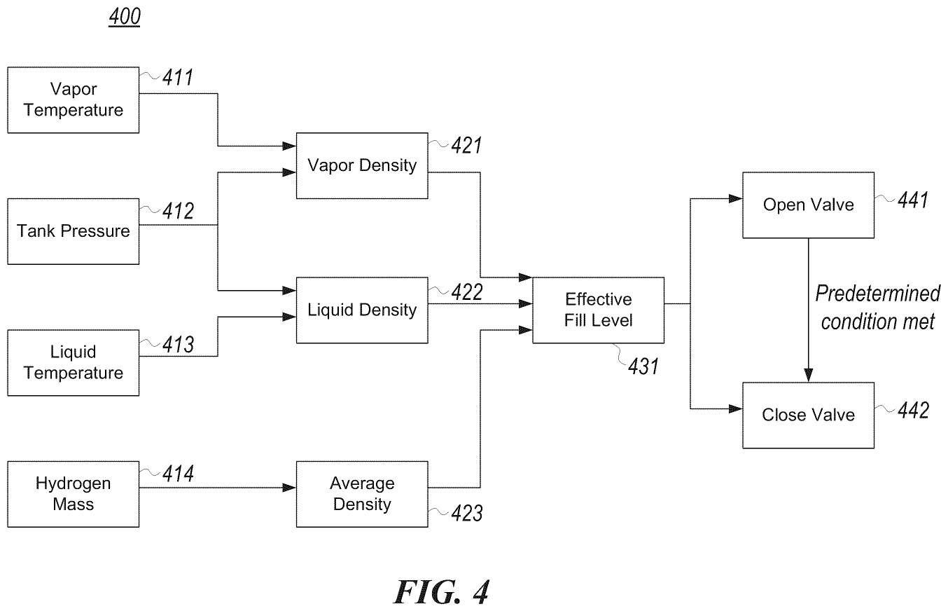

FIG. 4 is a flowchart 400 illustrating operation of an active venting control system of an embodiment to monitor the pressure, temperature, and hydrogen fill level within the tank to determine when to activate the active venting valve 140, so as to selectively release a minimum amount of hydrogen from the tank while maximizing the amount of hydrogen retained in the tank during storage and/or transport of the module to the aircraft or other vehicle. At step 411, one or more of the sensors 130 measure the temperature of the gaseous hydrogen fuel (“vapor temperature”) inside the tank module 20. At step 412, one or more of the sensors 130 measure the tank pressure inside the tank module 20. At step 413, one or more of the sensors 130 measure the temperature of the liquid hydrogen fuel (“liquid temperature”) inside the tank module 20. At step 414, one or more of the sensors 130 measure the mass of the hydrogen fuel (“hydrogen mass”) inside of the tank module 20. The measurements taken at steps 411, 412, 413, and 414 can be communicated to the controller 150, for example, in real-time, at fixed time intervals, or when requested by the controller 150. The number or timing of the measurements taken by the sensors 130 and communicated to the controller 150 can be adjusted by the controller as needed for the particular tank modules or the environment to which the tank modules will be exposed.

At step 421, the controller 150 calculates the vapor density within the tank module 20 based on, for example, the vapor temperature measured at step 411 and the tank pressure measured at step 412. At step 422, the controller 150 calculates the liquid density within the tank module 20 based on, for example, the tank pressure measured at step 412 and the liquid temperature measured at step 413. At step 423, the controller calculates the average density of hydrogen within the tank module 20 by, for example, dividing the hydrogen mass measured at step 414 by the known volume of the tank module 20. In some embodiments, the controller 150 uses other various sensor measurements to calculate the vapor density, the liquid density, the average density, and/or other parameters relating to the hydrogen fuel within the tank module 20.

At step 431, the controller 150 uses the vapor density, the liquid density, and the average density to calculate an effective fill level (i.e., effective percentage of total tank volume occupied by liquid hydrogen). For example, the effective fill level is equal to the quotient between (1) the difference between the average density and the vapor density, and (2) the difference between the liquid density and the vapor density, or

$$effective fill level = \frac{ρ - ρ v}{ρ l - ρ v}$$

where ρ is the average density, ρν is the vapor density, and μl is the liquid density. Still at step 431, the controller 150 can then compare the calculated effective fill level to an initial fill level threshold (e.g., in the range of approximately 90%-97%, and in some embodiments in the range of approximately 90%-95%). In other embodiments, the fill level can be measured directly (e.g., via the fill-level sensor 135). In some embodiments, the initial fill level threshold can be predetermined or calculated and adjusted over time.

If the calculated effective fill level is greater than the initial fill level threshold, the controller 150 goes to step 441 at which the controller moves the active venting valve 140 from the closed position to the open position. When the active venting valve 140 is in the open position, the tank module 20 is controllably vented to release some gaseous hydrogen, thereby decreasing the internal pressure and/or the effective fill level within the tank to below the initial fill level threshold. However, to prevent the tank module 20 from being vented for too long, resulting in unnecessary fuel loss, once a predetermined condition is met, the controller 150 moves the active venting valve 140 back to the closed position at step 442. In some embodiments, the predetermined condition can be when a certain amount of time has passed (e.g., 30 seconds, 60 seconds) or when a re-calculated effective fill level is below a certain secondary fill level threshold (e.g., in the range of approximately 80%-85%). In the illustrated embodiment, the secondary fill level threshold is less than the initial fill level threshold by a selected or determined amount. If the effective fill level initially calculated at step 431 is less than the initial fill level threshold, the controller 150 goes directly to step 442 at which the active venting valve remains in the closed position.

The active venting control system 100 is configured to continuously repeat the measurements, calculations, and determinations of the flowchart 400 at selected intervals while the tank modules with filled tanks are in storage or in transport and before the modules are loaded onto the aircraft or other vehicles and connected to the fuel system and the powertrain. In some embodiments, different combinations of sensor measurements are used to calculate the effective fill level. If the controller 150, sensors 130, and active venting valve 140 malfunction and do not adequately release pressure within the tank, the passive pressure relief valve 160 provides a backup and will open and release gas from the tank and provide automatic pressure relief if the tank's internal pressure exceeds an emergency upper pressure threshold.

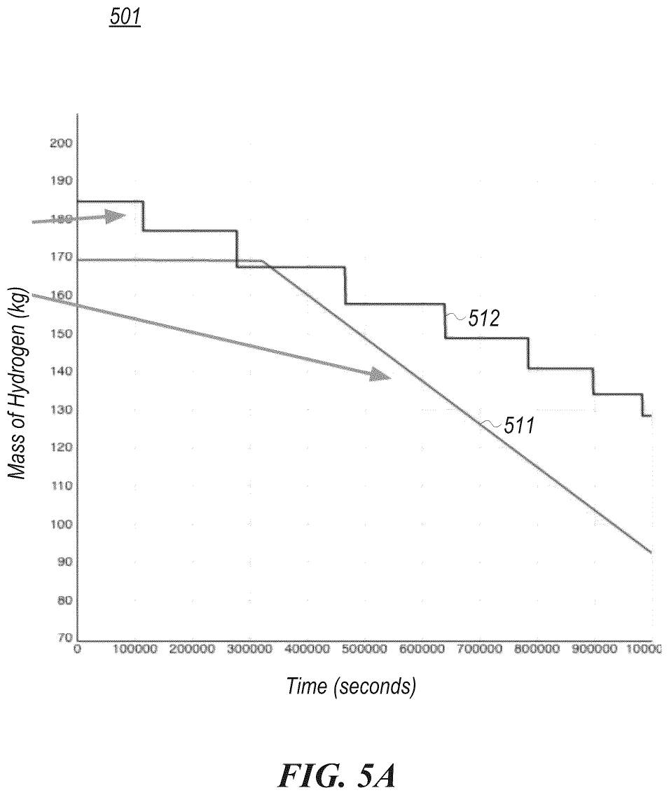

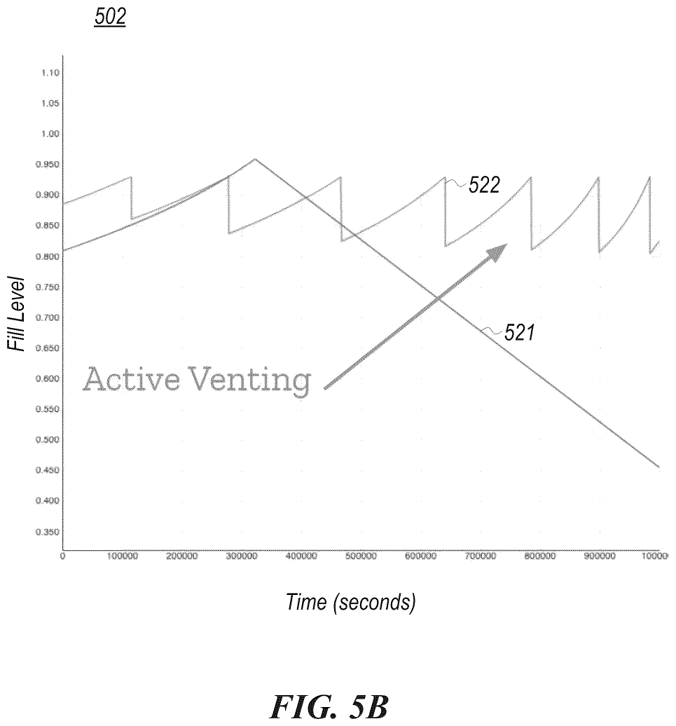

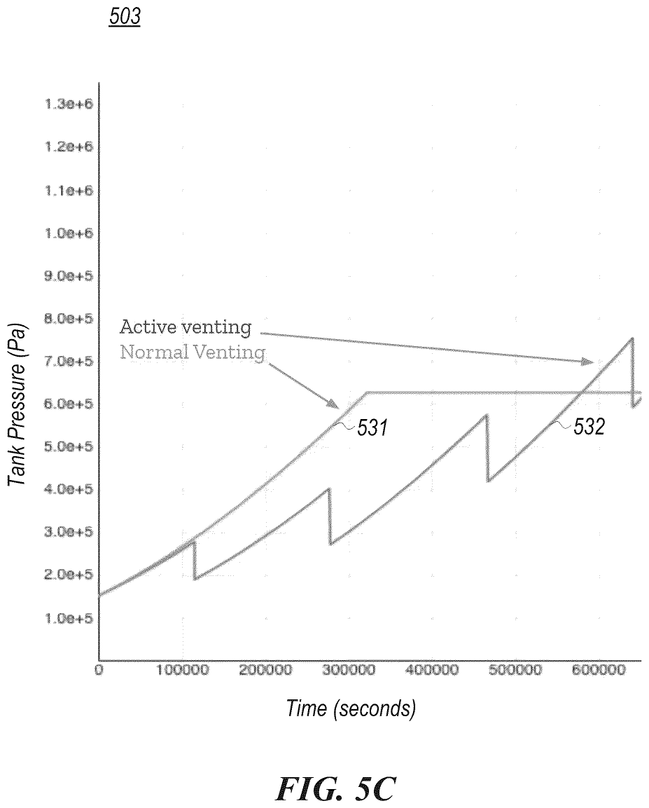

FIGS. 5A-C are schematic graphs illustrating hydrogen mass change, fill level change, and tank pressure change over time, respectively, in the liquid hydrogen fuel tank module 20 with the passive pressure relief valve 160 and the active venting valve 140 of the active venting control system 100 of one or more embodiments of the present technology. In FIG. 5A, the hydrogen mass schematic graph 501 illustrates the change in the mass of total hydrogen in a module's liquid hydrogen tank over time using the active venting control system 100, shown by plot 512, as compared to a conventional tank having only a passive pressure relief valve shown by plot 511. In FIG. 5B, the fill level schematic graph 502 illustrates the change in the fill level (with 1.00 meaning 100% capacity) in a module's liquid hydrogen tank over time using the active venting control system 100, shown by plot 522, as compared to a conventional tank having only a passive pressure relief valve shown by plot 521. In FIG. 5C, the tank pressure schematic graph 503 illustrates the change in the tank pressure in a module's liquid hydrogen tank over time using the active venting control system 100, shown by plot 532, as compared to a conventional tank having only a passive pressure relief valve shown by plot 531.

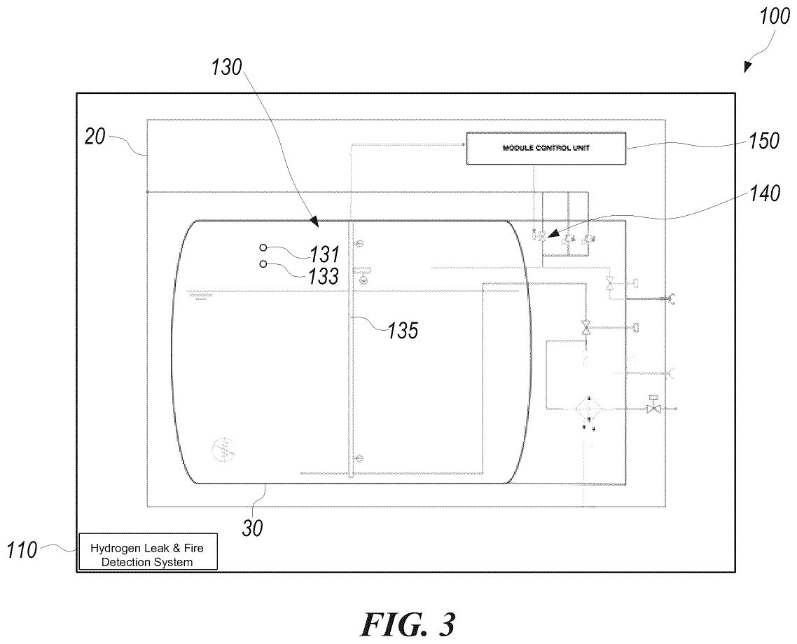

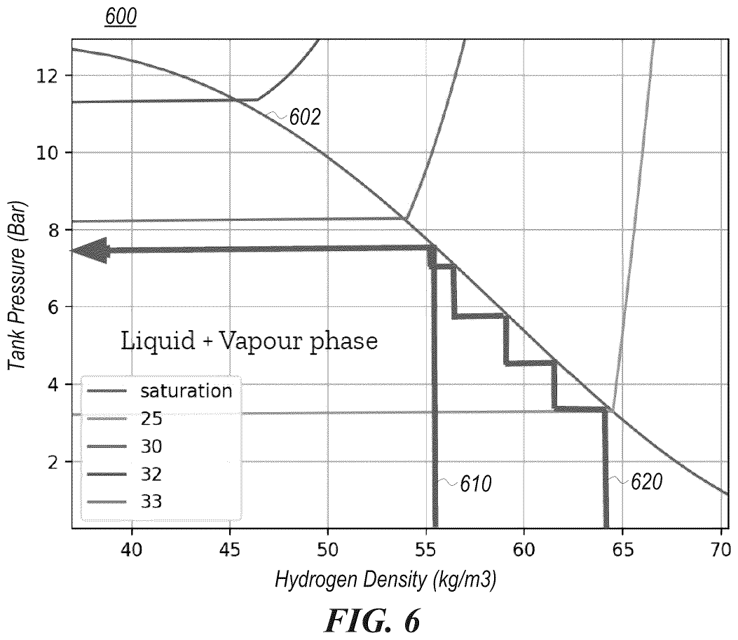

As an example, in FIG. 5A, at time=0 and with the liquid and vapor temperature close to saturation, the module's tank with the active venting control system 100 (FIG. 3) is initially filled with liquid hydrogen to an initial mass of approximately 185 kg. When the same size tank has only a passive pressure relief valve 160, at time=0, the tank for the same storage duration time can only be filled with liquid hydrogen to an initial mass of approximately 169 kg. As will be described in further detail with respect to FIG. 6 below, using the active venting valve 140 allows a tank to be filled with a higher initial hydrogen mass than a tank using just the passive pressure relief valve 160. For the illustrated embodiment with a maximum tank capacity of 209 kg, as shown in FIG. 5B, the initial fill level for the tank with the active venting control system 100 (FIG. 3) is approximately 0.89 (i.e., 89%) at time=0 as compared to an initial fill level of approximately 0.81 (i.e., 81%) at time=0 when the tank has only the passive pressure relief valve 160. As ambient heat transfers into the module's tank (e.g., due to imperfect thermal insulation), the liquid hydrogen inside expands, causing the fill level (i.e., percentage of total tank volume occupied by liquid hydrogen) and the tank pressure to both increase, as shown in FIGS. 5B and C. However, as shown in FIG. 5A for a period of time after time=0, the active vent valve 140 and the passive pressure relief valve 160 in each tank arrangement are closed, the respective tank is not vented, and the hydrogen mass remains constant, although the actual fill level in the tank initially begins to increase, as shown in FIG. 5B.

As seen in plot 531 of FIG. 5C, for the tank with just the passive pressure relief valve 160, the valve remains closed until a predetermined and fixed venting pressure is reached, which is approximately 620 kPa. This passive venting pressure is reached at approximately time=320,000 seconds. Once the passive venting pressure is reached, the passive pressure relief valve 160 opens so as to allow the tank pressure to remain at the fixed venting pressure. As a result, gaseous hydrogen is released at a rate proportional to the hydrogen gas expansion in the tank for ambient heat transfer into the tank module 20, and the hydrogen mass within the tank decreases, for example, linearly from time=320,000 seconds, as shown in FIG. 5A. As liquid hydrogen converts to gaseous hydrogen due to the heat transfer and is released through the passive pressure relief valve after time=320,000 seconds, the actual fill level of the liquid hydrogen stops increasing and begins to decrease, for example, linearly after time=320,000 seconds, as shown in FIG. 5B.

In contrast, the module's tank of the present technology with the active venting control system 100, the active vent valve 140 is configured to selectively open and close in response to instructions from the controller 150 based on data from the sensors 130. The controller 150 can operate according to the flowchart 400 illustrated in FIG. 4 and open the active venting valve 140 when the effective fill level reaches the initial fill level threshold. In the example illustrated in FIGS. 5A-5C (plots 512, 522, and 532, respectively) the tank at t=0 is filled to an initial mass of approximately 185 kg. When the valves closes, the pressure and fill level begin to increase after t=0. The initial fill level threshold is approximately 0.925 (i.e., 92.5%) when the hydrogen in the tank first reaches the initial fill level threshold at approximately time=115,000 seconds, as shown in FIG. 5B. The back-up passive pressure relief valve remains closed, but the active venting valve 140 is briefly opened, thereby releasing gaseous hydrogen from the tank and decreasing the tank's internal pressure as shown on plot 532 in FIG. 5C. The release of hydrogen gas through the open active venting valve allows the hydrogen mass and fill level to drop rapidly, as shown in FIGS. 5A (plot 512) and 5B (plot 522). After a predetermined amount of time or other condition, the controller 150 moves the active venting valve 140 back to the closed position. In the illustrated schematic graphs 501, 502, and 503, the amount of time the active venting valve is in the open position is indiscernible due to how short it is (e.g., up to a few minutes) compared to the overall approximately 200 hours of storage time for the illustrated embodiment. Accordingly, in plot 512 showing the hydrogen mass graph 501 over multiple cycles of controllably opening and closing the active venting valve 140, the plot appears to be a stepwise function. This arrangement is such that the mass of the hydrogen that can be stored in the tank with the active venting control system is greater than the tank with just the conventional passive pressure relief valve for almost the entire time from time=0 to time=1,00,000 seconds (>200 hrs), except for a short period of around 300,000 seconds (see FIG. 5A).

After the controller moves the active venting valve 140 back to the closed position, ambient heat continues to transfer into the tank module 20 as indicated above, which causes the fill level and the tank pressure to again rise. Each time the effective fill level reaches the initial fill level threshold, the controller 150 opens the active venting valve 140 again. In the illustrated example, the initial fill level threshold is kept constant (e.g., at 92.5%). In other embodiments, the controller can be configured to redefine the initial fill level threshold over time. In the illustrated example, the tank pressure when the active venting valve 140 is moved to the open position increases after each cycle of the active venting valve 140 being opened and closed, as shown by plot 532 in FIG. 5C. But, as seen in FIG. 5C, the pressure in the tank using the active venting control system 100 remains at or below the pressure in a similar tank using just the passive pressure relief valve for approximately time=0 to time=580,000 seconds (when using the active venting valve 140, the tank pressure can exceed the fixed venting pressure of the passive pressure relief valve 160).

In the illustrated example, plot 532 exceeds plot 531 at approximately time=580,000 seconds (˜160 hours). FIG. 5A also shows that the amount of hydrogen fuel (i.e., the mass of hydrogen) remaining in the tank module 20 after an extended storage period of approximately 200 hours (i.e., 720,000 seconds) is also much greater than the remaining mass of hydrogen in a tank that just uses the conventional passive pressure relief valve. Accordingly, the actual fill level of the hydrogen in a module's tank with the active venting control system 100 is substantively greater than the fill level in a tank using just the passive pressure relief valve over extended storage period (i.e., >200 hours), as seen in FIG. 5B. This means that the tank system with the active venting control system 100 of the present technology significantly reduces the amount of hydrogen fuel loss compared a liquid hydrogen tank using just the passive pressure relief valve 160. Moreover, the active venting valve 140 vents the hydrogen fuel tank module 20 such that the tank pressure exceeds the venting pressure of the passive pressure relief valve 160 without safety issues.

FIG. 6 is a schematic graph 600 illustrating a saturation curve 602 of hydrogen relative to a liquid hydrogen fuel tank with the active venting control system 100 of the present technology and relative to a conventional liquid hydrogen fuel tank with just a passive relief valve as discussed above. When the hydrogen's pressure and density establish a plot point below the saturation curve 602, the hydrogen is in the liquid+vapor phase. When the hydrogen's pressure and density establish a plot point on the graph above the saturation curve, the hydrogen is either in the saturated liquid or saturated vapor phase.

During storage of hydrogen in a liquid hydrogen storage tank, it is highly desirable to keep the pressure and density of the hydrogen in the tank below the saturation curve 602 (e.g., via venting, temperature control, etc.). Several issues may arise if the hydrogen fuel is above the curve 602 in the saturated liquid phase. For example, saturated liquid can have larger density variations, making it more difficult to control the fill level and reduces the efficiency of the fuel system. As another example, saturated liquid is more difficult to cool, which can lead to increased boil-off and subsequent over-pressurization.

The technology of the present disclosure the liquid hydrogen tank and the active venting control system 100 allows for storage of a greater mass of hydrogen in the tank while remaining below the saturation curve 602, as shown in plot 620, as compared to a liquid hydrogen tank with just the conventional passive reliever valve, as shown in plot 610. For purposes of comparison, when a conventional liquid hydrogen tank with the just passive pressure relief valve 160 is used, the pressure and density of the hydrogen follow plot 610. The conventional tank can be filled at an initial density of just over approximately 55 kg/m³ with a passive pressure relief level of about 7.5 bar. As ambient heat transfers into the tank, the tank pressure increases, and the hydrogen density remains constant as long as the passive pressure relief valve 160 remains closed. Once the pressure in the conventional tank reaches the 7.5 bar pressure level, the hydrogen in the tank will essentially reach the saturation curve 602, and the passive pressure relief value opens so the hydrogen will not go above the saturation curve 602 and to allow that tank pressure to remain at the 7.5 bar level. This results in a continual, linear loss of hydrogen fuel from the conventional tank, especially during extended storage times. Accordingly, the pressure threshold level of the conventional passive pressure relief valve essentially determines the maximum initial mass of hydrogen fuel (following the vertical portion of plot 610 downward) that can be put in and stored over time in the conventional liquid hydrogen tank. In addition, the pressure threshold level for the conventional pressure relief valve should not exceed the operational pressure of the hydrogen fuel once the conventional tank is connected to a fuel system. Otherwise, the pressure of the hydrogen fuel would need to be stepped down by the fuel system to reach the desired operational pressure, which adds to the complexity and cost of the fuel system.

In contrast, the module's liquid hydrogen tank with the active venting control system 100 of the present technology allows for more hydrogen to be added to the tank during the filling process and allows more hydrogen to remain in the module's tank over the extended storage period (e.g., >200 hours) while also ensuring that the hydrogen within the tank remains below the saturation curve. This is because the pressure, temperature, and fill level within the tank are actively monitored and the active control valve 140 can open and close multiple times as a function of conditions within the tank, as shown by plot 620. The active monitoring and controlling of the active venting valve 140 also allows the hydrogen within the tank to essentially follow the saturation curve 602 while still remaining below the saturation curve during extended storage and/or transport to the aircraft or other vehicle for subsequent use by the fuel and power train system. In the illustrated embodiment, the tank with the active venting control system can be initially filled with a hydrogen density of approximately 64 kg/m³, as compared to just over approximately 55 kg/m³ for the similarly sized conventional liquid hydrogen tank, as discussed above. This also means that, for the module's tank with the active venting control system 100 of the present technology, the maximum initial mass of hydrogen fuel that the tank can receive is not determined solely on the basis of the operation pressure requirement of the vehicle's fuel cell system, but also on the basis of how frequently and quickly the controller 150 opens and closes the active venting valve 140. The controller 150 can also be configured to maximize the hydrogen density within the tank during storage, and to adjust the pressure of the hydrogen to the operation pressure just before or as the module is being prepared for loading into the aircraft for connection to the aircraft's hydrogen fuel system. For example, the controller 150 can be configured to set the tank pressure to a value between approximately 6 bar and 8 bar at the end of a transit and storage period. It is noted that, while opening and closing the active venting valve 140 more frequently can allow the plot 620 to “zigzag” more closely to the saturation curve 602 and yield a higher maximum initial mass, the benefits must be balanced against the operational requirements and cyclical life of the active venting valve 140 and other components of the active venting control system. For example, the controller 150 can be configured to move the active venting valve 140 from the closed position to the open position at least three times within the transit and storage period, as illustrated in FIG. 6.

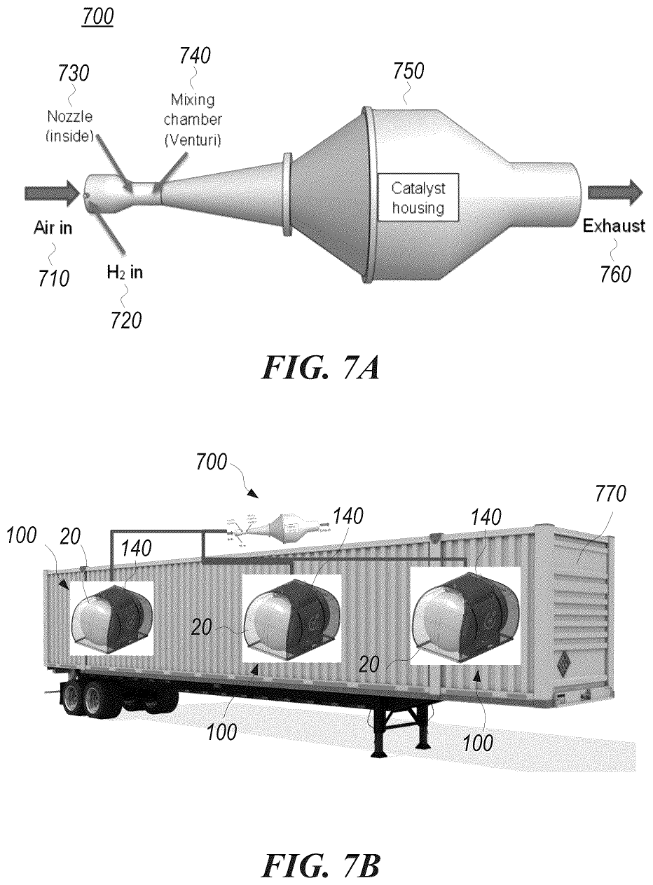

When the modules 20 (FIG. 7B) with the liquid hydrogen tanks with the active venting control system 100 of various embodiments of the present technology are in storage or being transported to the aircraft or other vehicle, some of the hydrogen fuel is actively vented out of the tanks as discussed above. This gaseous hydrogen fuel must be properly released in a safe manner. In one embodiment, the released gaseous hydrogen fuel can be released and directed through a catalyst to render the fuel non-volatile. For example, FIGS. 7A and 7B are side and schematic views of a catalyst 700 configured to be coupled to one or more of the modules 20 (FIG. 7B) containing the liquid hydrogen tank with the active venting control system 100. The catalyst 700 is configured to receive the vented gaseous hydrogen 720 as well as ambient air 710 through a nozzle 730. The ambient air 710 and the gaseous hydrogen 720 mix in a mixing chamber 740, and the resulting mixture is converted into water in a catalyst housing 750, which releases exhaust 760 such as water and heat. The catalyst 700 allows the released hydrogen gas to be processed safely and quickly without combustion while the hydrogen tanks remain in storage or in transport.

During transportation and/or storage of the modules and/or the tanks with the active venting control systems 100, the modules 100 can be secured inside an enclosed space, such as a trailer 770 or other storage facility. The catalyst 700 can be coupled to the exhaust line carrying the vented hydrogen gas, and the catalyst exhaust can be safely directed to the ambient environment external of the trailer or other enclosed space containing the modules, tanks, and active venting control systems.

In some embodiments, the catalyst 700 can also be coupled to receive vented gaseous hydrogen from passive pressure relief valves 160 in addition to the active venting valves 140. In the illustrated embodiment, a single catalyst 700 is coupled to multiple tank modules 20. In some embodiments, the tank modules 20 are coupled to multiple catalysts 700. In some embodiments, the catalyst 700 is decoupled from the hydrogen fuel active venting control systems 100 before the systems 100 are loaded onto the aircraft 10.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. It shall be understood that all aspects of the disclosure are not limited to the specific depictions, configurations, or relative proportions set forth herein, which depend upon a variety of conditions and variables. It should be understood that various alternatives to the embodiments of the disclosure described herein may be employed in practicing the disclosure. It is therefore contemplated that the disclosure shall also cover any such alternatives, modifications, variations, or equivalents. It is intended that the following claims define the scope of the disclosure and that methods and structures within the scope of these claims and their equivalents be covered thereby.

We claim:

1. A liquid hydrogen tank assembly, comprising:
a liquid hydrogen fuel tank configured to contain hydrogen fuel in liquid and gaseous states, wherein the hydrogen fuel tank has a tank volume;
a passive pressure relief valve coupled to the interior of the liquid hydrogen fuel tank and configured to automatically move to a first open position when an interior pressure within the tank volume exceed a relief pressure threshold;
a plurality of sensors operatively coupled to the liquid hydrogen fuel tank and configured to measure conditions within the liquid hydrogen fuel tank, wherein the plurality of sensors include a first pressure sensor configured to determine an interior pressure within the tank volume and a second fill level sensor configured to obtain data to determine a fill level of the liquid hydrogen within the tank volume;
an active venting control system coupled to the liquid hydrogen fuel tank and to the plurality of sensors, the active venting control system comprising:
an active venting valve operatively communicating with the gaseous hydrogen located above the liquid hydrogen in the tank volume, the active venting valve being movable between a closed position and second open position;
a controller coupled to the plurality of sensors and to the active venting valve, the controller being: configured to use the information from the plurality of sensors to determine an effective fill level of the liquid hydrogen in the tank volume and the pressure within the tank volume, configured to move the active venting valve from the closed position to the second open position when the effective fill level exceeds an initial fill level threshold, and configured to move the active venting valve to the closed position when a secondary threshold is reached after reaching the initial fill level threshold, wherein the secondary threshold is different than the initial fill level threshold.

2. The assembly of claim 1 wherein the plurality of sensors are operatively coupled to the hydrogen fuel tank and are configured to measure within the tank volume at least one of a liquid hydrogen temperature, a vapor temperature, the tank pressure, or a hydrogen mass, wherein the liquid temperature is a temperature reading of the liquid hydrogen, wherein the vapor temperature is a temperature reading of the gaseous hydrogen, wherein the tank pressure a pressure reading of the interior pressure within the hydrogen fuel tank, and wherein the hydrogen mass is a total mass of the liquid hydrogen and the gaseous hydrogen.

3. The assembly of claim 1 wherein the controller is configured to calculate a hydrogen vapor density based on the vapor temperature and the tank pressure, a liquid density based on the liquid temperature and the tank pressure, an average density based on the hydrogen mass and the tank volume, and the effective fill level calculated by the controller is based on the hydrogen vapor density, the liquid density, and the average density.

4. The assembly of claim 3 wherein the controller is configured to compare the calculated effective fill level to the initial fill level threshold.

5. The assembly of claim 1 wherein the secondary threshold is a secondary fill level threshold that is less than initial fill level threshold, and the controller is configured to move the active venting valve to the second closed position when the effective fill level reaches the secondary fill level threshold.

6. The assembly of claim 1 wherein the controller is configured to move the active venting valve from the open position to the second closed position after a predetermined time period after moving the active venting valve to the open position.

7. The assembly of claim 1 wherein the hydrogen fuel tank and the active venting control system configured to enable the hydrogen fuel tank to be filled with liquid hydrogen to an initial mass of approximately 195 kg and an initial fill level in the range of approximately 90%-95% of the tank's interior volume, and to allow for storage of approximately 200 hours with retention of about 158 kg of hydrogen in the tank after the storage after active venting during the storage.

8. The assembly of claim 7 wherein the initial fill level is approximately of 92% of the tank's interior volume.

9. The assembly of claim 1 wherein the predetermined fill level is based on a saturation curve of hydrogen.

10. The assembly of claim 1 wherein the active venting valve is coupled to a catalyst, wherein the catalyst is configured to convert gaseous hydrogen released through the active venting valve into an exhaust containing water.

11. A liquid hydrogen tank module assembly, comprising:
a module housing;
a liquid hydrogen fuel tank within the housing and configured to contain liquid hydrogen at cryogenic conditions and gaseous hydrogen in a headspace above the liquid hydrogen, wherein the hydrogen fuel tank has a tank volume;
a plurality of sensors operatively coupled to the hydrogen fuel tank and configured to measure a liquid temperature, a vapor temperature, a tank pressure, and a hydrogen mass, wherein the liquid temperature is a temperature reading of the liquid hydrogen, wherein the vapor temperature is a temperature reading of the gaseous hydrogen, wherein the tank pressure is a pressure reading of an interior of the hydrogen fuel tank, and wherein the hydrogen mass is a total mass of the liquid hydrogen and the gaseous hydrogen;
a passive pressure relief valve coupled to the interior of the hydrogen fuel tank and configured to automatically move to a first open position when the tank pressure exceeds a relief pressure threshold; and
an active venting control system coupled to the hydrogen fuel tank, the active venting control system comprising:
an active venting valve operatively coupled to the hydrogen fuel tank and being in communication with the gaseous hydrogen, the active venting valve being movable between a closed position and a second open position; and
a controller configured to receive outputs from the sensors and calculate a vapor density based on the vapor temperature and the tank pressure, a liquid density based on the liquid temperature and the tank pressure, an average density based on the hydrogen mass and the tank volume, and an effective fill level based on the vapor density, the liquid density, and the average density,
wherein the controller is configured to move the active venting valve from the closed position to the second open position when the effective fill level exceeds an initial fill level threshold, and move the active venting valve to the closed position when a secondary threshold is reached after reaching the initial fill level threshold.

12. The assembly of claim 11 wherein the secondary threshold is a secondary fill level threshold that is less than initial fill level threshold, and wherein the controller is configured to move the active venting valve to the closed position when the effective fill level reaches the secondary fill level threshold.

13. The assembly of claim 11 wherein the secondary threshold is a predetermined time period, and wherein the controller is configured to move the active venting valve to the closed position when the predetermined time period elapses after reaching the initial fill level threshold.

14. The assembly of claim 11 wherein the initial fill level threshold ranges between approximately 90%-95% of the tank volume.

15. The assembly of claim 11 wherein the initial fill level threshold is based on a saturation curve of hydrogen.

16. The assembly of claim 11 wherein the controller is configured to move the active venting valve from the closed position to the second open position at least three times within a transit and storage period.

17. The assembly of claim 11 wherein the controller is configured to set the tank pressure to be between approximately 6 bar and 8 bar at an end of a transit and storage period.

18. The assembly of claim 11 wherein the active venting valve is coupled to a catalyst, wherein the catalyst is configured to convert gaseous hydrogen released through the active venting valve into an exhaust containing water.

19. The assembly of claim 11, further comprising a cold box coupled to the liquid hydrogen fuel tank and configured to contain hydrogen lines coupled to the interior volume in and controlled environment different than an ambient environment surrounding the liquid hydrogen fuel tank.

20. A liquid hydrogen tank assembly, comprising:
a liquid hydrogen fuel tank configured to contain liquid hydrogen at cryogenic conditions and gaseous hydrogen in a headspace above the liquid hydrogen, wherein the hydrogen fuel tank has a tank volume;
a plurality of sensors operatively coupled to the hydrogen fuel tank and configured to measure a liquid temperature, a vapor temperature, a tank pressure, and a hydrogen mass in the tank; and
an active venting control system coupled to the hydrogen fuel tank, the active venting control system comprising:
an active venting valve operatively coupled to the hydrogen fuel tank and being in communication with the gaseous hydrogen, the active venting valve being movable between a closed position and an open position; and
a controller configured to receive outputs from the sensors and calculate a vapor density based on the vapor temperature and the tank pressure, a liquid density based on the liquid temperature and the tank pressure, an average density based on the hydrogen mass and the tank volume, and an effective fill level based on the vapor density, the liquid density, and the average density,
wherein the controller is configured to cause the active venting valve to move from the closed position to the open position when the effective fill level exceeds an initial fill level threshold, and the controller is configured to cause the active venting valve to move the active venting valve to the closed position when a secondary threshold is reached after reaching the initial fill level threshold.
